(19) United States
(12) Patent Application Publication
(10) Pub. No.: US 2011/0306533 A1
(43) Pub. Date: Dec. 15, 2011

(54) USE OF COMB POLYMERS AS ANTIFATIGUE ADDITIVES

(75) Inventors: Boris Eisenberg, Heppenheim (DE); Torsten Stoehr, Frankfurt (DE); Dieter Janssen, Umstadt (DE); Miriam Kathrin Stihulka, Maintal (DE)

(73) Assignee: Evonik Rohmax Additives GmbH, Darmstadt (DE)

(21) Appl. No.: 13/202,744

(22) PCT Filed: Feb. 25, 2010
(86) PCT No.: PCT/EP2010/052361

§ 371 Date: Aug. 22, 2011

(30) Foreign Application Priority Data
Mar. 10, 2009 (DE) 10 2009 001 446.2

(51) Int. Cl. C10M 145/14; C08F 220/60; C08F 220/10; C08F 220/34

(52) U.S. Cl. 508/471; 526/312; 526/307; 526/329.2; 508/470; 508/469

(57) ABSTRACT

The invention relates to the use of comb polymers comprising repeating units in the main chain which repeating units are derived from polyolefin-based macromonomers having a molecular weight of at least 500 g/mol, and repeating units which are derived from low-molecular monomers having a molecular weight of less than 500 g/mol as antifatigue additives in lubricants. The invention further relates to novel comb polymers and methods for the production thereof and to lubricating oils comprising said comb polymers.

The present invention relates to the use of comb polymers as antifatigue additives. The present invention further describes comb polymers with improved properties and processes for preparation thereof. The present invention further relates to a lubricant oil composition comprising the comb polymers detailed above.

For reasons of fuel economy, a task being addressed in modern research is that of reducing churning loss and internal friction of oils to an ever greater degree. As a result, there has been a trend in the last few years toward ever lower viscosities of the oils used and hence ever thinner lubricant films, especially at high temperatures. An adverse consequence of this trend is the fact that an increased level of damage, especially on transmissions and roller bearings, is occurring in use.

In the design of a transmission, it should be ensured that all sliding and rolling contact sites, i.e. gearings and roller bearings, are lubricated sufficiently in all operating states. Damage to gears and roller bearings are the consequence of excessive local stress. A distinction is drawn here between two groups of faults at metallic surfaces of transmissions, especially at gearings and roller bearings:
1. Wear resulting from continuous surface material removal or scuffing as a result of abrupt material removal after surface wear of both friction partners.
2. Fatigue which becomes visible through gray staining (surface fatigue, micro-pitting) or craters (sub-surface fatigue, pitting). This damage is caused by flaking-off or breaking-out of material owing to cracks, which are caused 20-40 μm or 100-500 μm below the surface by shear stresses in the metal lattice.

The types of damage mentioned are commonly known for gearings and roller bearings, and are described in detail, for example, in the publications “Gears—Wear and Damage to Gear Teeth”, ISO DIS 10825 and “Wälzlagerschäden” [Damage to roller bearings], Publ.-No. WL 82 102/2 DA from FAG (Schaeffler KG), Schweinfurt 2004.

Wear resulting from continuous surface material removal occurs on gearings and roller bearings preferentially at low speeds, at which the surface roughnesses come into contact owing to too thin a lubricant film. The material degradation which results from this mechanism is shown, for example, in FIG. 10.10 in T. Mang, W. Dresel (eds.): “Lubricants and Lubrication”, Wiley-VCH, Weinheim 2001, in which a tooth flank with significant manifestations of wear is shown. Inhomogeneous wear, which can be seen in the form of streak formation on a roller body, is shown in “Wälzlagerschäden”, Publ.-No. WL 82 102/2 DA from FAG (Schaeffler KG), Schweinfurt 2004, in FIG. 68.

Lubricants have a favorable effect with regard to wear resistance when they comprise antiwear (AW) additives and are of high viscosity.

Scuffing on tooth flanks usually occurs at moderate to high speeds. The surfaces in contact become welded briefly and immediately fall apart again. A typical manifestation of such damage is shown, for example, in FIG. 10.11 in T. Mang, W. Dresel (eds.): “Lubricants and Lubrication”, Wiley-VCH, Weinheim 2001. The damage occurs on intermeshing flank areas, where very high sliding speeds are present (often on the tooth head). This is damage which occurs abruptly, which can be caused merely by a single overload. Scuffing damage likewise occurs in roller bearings; this is observed especially on large bearings, for example in transmissions of cement mills. Owing to excessively low operating viscosity, excessively high stresses and/or excessively high speeds, there is insufficient lubricant film formation between the rollers and cup (for example of a tapered roller bearing), which leads to local welding (cf. FIG. 81 “Wälzlagerschäden”, Publ.-No. WL 82 102/2 DA from FAG (Schaeffler KG), Schweinfurt 2004).

Scuffing damage can be reduced by more than a factor of 5 by extreme pressure (EP) additives in the lubricant.

The material fatigue described above under point 2 is manifested especially by gray staining and crater formation.

Gray staining begins at first 20-40 μm below the surface with fine cracks in the metal lattice. The crack propagates to the surface and leads to material flaking off, which is evident as visible gray staining. In the case of gearings, gray staining can be observed on tooth flanks virtually in all speed ranges. Gray staining occurs preferentially in the area of sliding contact, which is shown, for example, in FIG. 10.13 in T. Mang, W. Dresel (eds.): “Lubricants and Lubrication”, Wiley-VCH, Weinheim 2001. In roller bearings too, very flat eruptions arise as gray staining on the raceway in the area of sliding contact, as shown by way of example in “Wälzlagerschäden”, Publ.-No. WL 82 102/2 DA from FAG (Schaeffler KG), Schweinfurt 2004, in FIG. 49.

Crater formation is likewise fatigue damage which is observed in all speed ranges. Here too, the damage begins with a crack in the metal lattice at a depth of 100-500 μm. The crack finally propagates to the surface and leaves, after break-out, a pronounced crater. In the case of gears, these craters occur preferably at the middle of the tooth flanks, and in roller bearings usually on the rotating bearing rings. Figures showing this damage can be found in publications including T. Mang, W. Dresel (eds.): “Lubricants and Lubrication”, Wiley-VCH, Weinheim 2001 (cf. FIG. 10.14 and FIG. 10.15) and in “Wälzlagerschäden”, Publ.-No. WL 82 102/2 DA from FAG (Schaeffler KG), Schweinfurt 2004 (cf. FIG. 43). In contrast to gray staining, the damage thus proceeds in the area of rolling contact, since the greatest stress and the greatest amplitudes of load change are present there in each case.

In clear contrast to the faults of “wear” and “scuffing”, the much more serious fatigue faults of “gray staining” and “craters” at present cannot be influenced in a controlled manner with additives, for instance the antiwear and extreme pressure additives described above (cf. R. M. Mortier, S. T. Orszulik (eds.): “Chemistry and Technology of Lubricants”, Blackie Academic & Professional, London, 2^{nd} ed. 1997; J. Bartz: “Additive für Schmierstoffe” [Additives for Lubricants], Expert-Verlag, Renningen-Malmsheim 1994; T. Mang, W. Dresel (eds.): “Lubricants and Lubrication”, Wiley-VCH, Weinheim 2001). Studies to date have been able to show, if anything, only that gray staining resistance and crater resistance can be influenced via the lubricant viscosity. An increased viscosity here has a prolonging effect on fatigue time (cf. U. Schedl: “FVA-Forschungsvorhaben 2/IV: Pittingtest—Einfluss der Schmierstoffs auf die Grübchenlebensdauer einsatzgehärteter Zahnräder im Einstufen- and Lastkollektivversuch”, Forschungsvereinigung Antriebstechnik, Book 530, Frankfurt 1997).

To improve the viscosity properties, polyalkyl (meth)acrylates (PAMA) have been used for some time in lubricant oils, for example transmission or motor oils, and some of them may be functionalized with comonomers, especially nitrogen- or oxygen-containing monomers. These VI improvers include especially polymers which have been functionalized with dimethylaminoethyl methacrylate (U.S. Pat. No. 2,737,496 to E. I. Dupont de Nemours and Co.), dimethylaminoethylmethacrylamide (U.S. Pat. No. 4,021,357 to Texaco Inc.) or hydroxyethyl methacrylate (U.S. Pat. No. 3,249,545 to Shell Oil. Co).

VI improvers based on PAMA for lubricant oil applications are constantly being improved. For instance, there have recently also been many descriptions of polymers with block sequences for use in lubricant oils.

For example, publication U.S. Pat. No. 3,506,574 to Rohm and Haas describes sequential polymers consisting of a PAMA base polymer, which is grafted with N-vinylpyrrolidone in a subsequent reaction.

A widespread class of commercial VI improvers is that of hydrogenated styrene-diene copolymers (HSDs). These HSDs may be present either in the form of (—B-A)ₙ stars (U.S. Pat. No. 4,116,917 to Shell Oil Company) or in the form of A-B diblock and A-B-A triblock copolymers (U.S. Pat. No. 3,772,196 and U.S. Pat. No. 4,788,316 to Shell Oil Company). In this context, A represents a block of hydrogenated polyisoprene, and B a divinylbenzene-crosslinked polystyrene core or a block of polystyrene. The Infineum SV series from Infineum International Ltd., Abingdon, UK includes products of this type. Typical star polymers are Infineum SV 200, 250 and 260. Infineum SV 150 is a diblock polymer. The products mentioned are free carrier oils or solvents. Especially the star polymers such as Infineum SV 200 are exceptionally advantageous with regard to thickening action, viscosity index and shear stability. Further star polymers are described inter alia in WO 2007/025837 (RohMax Additives).

In addition, it is also possible to use polyalkyl (meth)acrylates (PAMAs) to improve the viscosity index (VI). For instance, EP 0 621 293 and EP 0 699 694 to Röhm GmbH describe advantageous comb polymers. A further improvement in the VI can be achieved according to the teaching of WO 2007/003238 (RohMax Additives) by complying with specific parameters. Effectiveness as an antiwear additive is not detailed in these publications.

Advantageous properties with regard to soot dispersion (piston cleanliness), antiwear properties and altered coefficients of friction in motor oils can be established in conventional PAMA chemistry by grafting of N-vinyl compounds (usually N-vinylpyrrolidone) onto PAMA base polymers (DE 1 520 696 to Rohm and Haas and WO 2006/007934 to RohMax Additives). VISCOPLEX® 6-950 is such a PAMA which is obtainable commercially from RohMax Additives, Darmstadt, Germany.

Moreover, publications WO 2001/40339 and DE 10 2005 041 528 to RohMax Additives GmbH describe, respectively, block copolymers and star block copolymers for lubricant oil applications, which are obtainable by means of ATRP among other methods.

Advantageousness of the block structure for wear-reducing additive functions of the VI improvers or for reducing friction, which leads to lower fuel consumption, has also already been demonstrated.

WO 2004/087850 describes lubricant oil formulations which comprise block copolymers and have excellent friction properties. The block copolymers act as friction modifiers.

WO 2006/105926 describes, inter alia, block copolymers derived from specially selected N/O-functional monomers, and the use thereof as friction modifiers and dispersants.

WO 2006/007934 to RohMax Additives GmbH describes the use of graft polymers as an antiwear additive in lubricant oil formulations, especially in motor oils. WO 2005/097956 to RohMax Additives likewise describes lubricant oil formulations comprising H-bond-containing graft polymers as antiwear additives.

As described above, there have been many attempts to date to prevent damage owing to wear or scuffing through use of additives. However, material fatigue can only be countered by the use of oils with a relatively high viscosity or by use of specific materials for gearing and/or roller bearings. However, both options are afflicted with disadvantages, the use of new materials being expensive and a further improvement being desirable. The use of high-viscosity oils leads to high internal friction and hence to high fuel consumption. Therefore, especially compounds which can be used as antifatigue additives, without this being associated with an increase in viscosity of the lubricant, would be helpful.

In view of the prior art, it was thus an object of the present invention to provide an additive which leads to a reduction in material fatigue (antifatigue additive). This should especially achieve a reduction in the above-described formation of gray staining (surface fatigue, micro-pitting) or craters (sub-surface fatigue, pitting).

It was a further object of the invention to provide additives which can be produced in a simple and inexpensive manner, and commercially available components in particular should be used. At the same time, production should be possible on the industrial scale, without new plants or plants of complex construction being required for that purpose.

It was a further aim of the present invention to provide an additive which brings about a multitude of desirable properties in the lubricant. This can minimize the number of different additives.

Furthermore, the additive should not exhibit any adverse effects on the fuel consumption or the environmental compatibility of the lubricant.

In addition, the additives should have a particularly long service life and low degradation during use, such that correspondingly modified lubricant oils can be used over a long period.

These objects, and further objects which are not stated explicitly but can be immediately derived or discerned from the connections described herein by way of introduction, are achieved by the use of comb polymers having all features of claim 1. A particularly advantageous solution is given by the comb polymers detailed in claims 7 and 16. Appropriate modifications to the inventive comb polymers are protected in the dependent claims which refer back to claims 7 and 16. With regard to the process for preparing comb polymers, claim 26 offers a solution to the underlying problem, while claim 28 protects a lubricant oil composition comprising the comb polymers of the present invention.

The present invention accordingly provides for the use of comb polymers comprising, in the main chain, repeat units derived from polyolefin-based macromonomers with a molecular weight of at least 500 g/mol, and repeat units derived from low molecular weight monomers with a molecular weight less than 500 g/mol, as antifatigue additives in lubricants.

Particular advantages can surprisingly be achieved by particular comb polymers which are provided by the present invention. The present invention accordingly further provides a comb polymer comprising, in the main chain, repeat units derived from polyolefin-based macromonomers with a molecular weight of at least 500 g/mol, and repeat units derived from low molecular weight monomers with a molecular weight less than 500 g/mol, which is characterized in that the comb polymer has repeat units derived from alkyl (meth)acrylates having 8 to 30 carbon atoms in the alcohol group, a polarity of at least 50% THF and a limiting viscosity in the range from 15 to 50 ml/g.

The present invention further provides a comb polymer comprising, in the main chain, repeat units derived from polyolefin-based macromonomers with a molecular weight of at least 500 g/mol, and repeat units derived from low molecular weight monomers with a molecular weight less than 500 g/mol, which is characterized in that the comb polymer has at least 10% by weight of repeat units derived from styrene monomers having 8 to 17 carbon atoms, at least 5% by weight of repeat units derived from alkyl (meth)acrylates having 1 to 6 carbon atoms, and a polarity of at least 30% THF.

It is thus possible in an unforeseeable manner to provide an additive for lubricant oils, which leads to a reduction in material fatigue (antifatigue additive). At the same time, these additives achieve a decrease in the above-described formation of gray staining (surface fatigue, micro-pitting) or craters (sub-surface fatigue, pitting).

Furthermore, these additives can be produced in a simple and inexpensive manner, and it is possible to use commercially available components in particular. At the same time, production is possible on the industrial scale, without new plants or plants of complex construction being required for that purpose.

Furthermore, the polymers for use in accordance with the invention exhibit a particularly favorable profile of properties. For instance, the polymers can be configured so as to be surprisingly shear-stable, such that the lubricants have a very long service life. In addition, the additive for use in accordance with the invention may bring about a multitude of desirable properties in the lubricant. For example, it is possible to produce lubricants with outstanding low-temperature properties or viscosity properties, which comprise the present comb polymers. This allows the number of different additives to be minimized. Furthermore, the present comb polymers are compatible with many additives. This allows the lubricants to be adjusted to a wide variety of different requirements.

Furthermore, the additives for use do not exhibit any adverse effects on fuel consumption or the environmental compatibility of the lubricant. In addition, the inventive comb polymers can be prepared in a simple and inexpensive manner, and commercially available components in particular can be used. Furthermore, the comb polymers of the present invention can be prepared on the industrial scale without new plants or plants of complex construction being required for that purpose.

The term “comb polymer” used herein is known per se, meaning that relatively long side chains are bonded to a polymeric main chain, frequently also known as the backbone. In the present case, the inventive polymers have at least one repeat unit derived from polyolefin-based macromonomers.

The term “main chain” does not necessarily mean that the chain length of the main chain is greater than that of the side chains. Instead, this term relates to the composition of this chain. While the side chain has very high proportions of olefinic repeat units, especially units derived from alkenes or alkadienes, for example ethylene, propylene, n-butene, isobutene, butadiene, isoprene, the main chain is derived from major proportions of more polar unsaturated monomers including other alkyl (meth)acrylates, styrene monomers, fumarates, maleates, vinyl esters and/or vinyl ethers.

The term “repeat unit” is widely known in the technical field. The present comb polymers can preferably be obtained by means of free-radical polymerization of macromonomers and low molecular weight monomers. In this reaction, double bonds are opened up to form covalent bonds. Accordingly, the repeat unit arises from the monomers used. However, the present comb polymers can also be obtained by polymer-analogous reactions and/or graft copolymerization. In this case, the converted repeat unit of the main chain is counted as the repeat unit derived from a polyolefin-based macromonomer. The same applies in the case of preparation of the inventive comb polymers by graft copolymerization.

The present invention describes comb polymers which preferably have a high oil solubility. The term “oil-soluble”means that a mixture of a base oil and an inventive comb polymer which has at least 0.1% by weight, preferably at least 0.5% by weight, of the inventive comb polymers is preparable without macroscopic phase formation. The comb polymer can be present in dispersed and/or dissolved form in this mixture. The oil solubility depends in particular on the proportion of lipophilic side chains and on the base oil. This property is known to those skilled in the art and can be adjusted for the particular base oil easily via the proportion of lipophilic monomers.

The inventive comb polymers comprise repeat units derived from polyolefin-based macromonomers. Polyolefin-based macromonomers are known in the technical field. These repeat units comprise at least one group derived from polyolefins. Polyolefins are known in the technical field, and can be obtained by polymerizing alkenes and/or alkadienes which consist of the elements carbon and hydrogen, for example C2-C10-alkenes such as ethylene, propylene, n-butene, isobutene, norbornene, and/or C4-C10-alkadienes such as butadiene, isoprene, norbornadiene. The repeat units derived from polyolefin-based macromonomers comprise preferably at least 70% by weight and more preferably at least 80% by weight and most preferably at least 90% by weight of groups derived from alkenes and/or alkadienes, based on the weight of the repeat units derived from polyolefin-based macromonomers. The polyolefinic groups may in particular also be present in hydrogenated form. In addition to the groups derived from alkenes and/or alkadienes, the repeat units derived from polyolefin-based macromonomers may comprise further groups. These include small proportions of copolymerizable monomers. These monomers are known per se and include, among other monomers, alkyl (meth)acrylates, styrene monomers, fumarates, maleates, vinyl esters and/or vinyl ethers. The proportion of these groups based on copolymerizable monomers is preferably at most 30% by weight, more preferably at most 15% by weight, based on the weight of the repeat units derived from polyolefin-based macromonomers. In addition, the repeat units derived from polyolefin-based macromonomers may comprise start groups and/or end groups which serve for functionalization or are caused by the preparation of the repeat units derived from polyolefin-based macro-monomers. The proportion of these start groups and/or end groups is preferably at most 30% by weight, more preferably at most 15% by weight, based on the weight of the repeat units derived from polyolefin-based macromonomers.

The number-average molecular weight of the repeat units derived from polyolefin-based macromonomers is preferably in the range from 500 to 50 000 g/mol, more preferably 700 to 10 000 g/mol, especially 1500 to 5500 g/mol and most preferably 4000 to 5000 g/mol.

In the case of preparation of the comb polymers by copolymerization of low molecular weight and macro-molecular monomers, these values arise through the properties of the macromolecular monomers. In the case of polymer-analogous reactions, this property arises, for example, from the macroalcohols and/or macroamines used, taking account of the converted repeat units of the main chain. In the case of graft copolymerizations, the proportion of polyolefins formed which have not been incorporated into the main chain can be used to conclude the molecular weight distribution of the polyolefin.

The repeat units derived from polyolefin-based macromonomers preferably have a low melting point, which is measured by means of DSC. The melting point of the repeat units derived from the polyolefin-based macromonomers is preferably less than or equal to −10° C., especially preferably less than or equal to −20° C., more preferably less than or equal to −40° C. Most preferably, no DSC melting point can be measured for the repeat units derived from the polyolefin-based macromonomers.

In addition to the repeat units derived from the polyolefin-based macromonomers, the inventive comb polymers comprise repeat units derived from low molecular weight monomers with a molecular weight less than 500 g/mol. The expression “low molecular weight” makes it clear that some of the repeat units of the backbone of the comb polymer have a low molecular weight. Depending on the preparation, this molecular weight may result from the molecular weight of the monomers used to prepare the polymers. The molecular weight of the low molecular weight repeat units or of the low molecular weight monomers is preferably at most 400 g/mol, more preferably at most 200 g/mol and most preferably at most 150 g/mol. These monomers include alkyl (meth)acrylates, styrene monomers, fumarates, maleates, vinyl esters and/or vinyl ethers.

The preferred low molecular weight monomers include styrene monomers having 8 to 17 carbon atoms, alkyl (meth)acrylates having 1 to 30 carbon atoms in the alcohol group, vinyl esters having 1 to 11 carbon atoms in the acyl group, vinyl ethers having 1 to 30 carbon atoms in the alcohol group, (di)alkyl fumarates having to 30 carbon atoms in the alcohol group, (di)alkyl maleates having 1 to 30 carbon atoms in the alcohol group, and mixtures of these monomers derived are. These monomers are widely known in the technical field.

Examples of styrene monomers having 8 to 17 carbon atoms are styrene, substituted styrenes having an alkyl substituent in the side chain, for example α-methyl-styrene and α-ethylstyrene, substituted styrenes having an alkyl substituent on the ring, such as vinyltoluene and p-methylstyrene, halogenated styrenes, for example monochlorostyrenes, dichlorostyrenes, tribromostyrenes and tetrabromostyrenes.

The expression “(meth)acrylates” encompasses acrylates and methacrylates, and also mixtures of acrylates and methacrylates. The alkyl (meth)acrylates having 1 to 30 carbon atoms in the alcohol group include especially (meth)acrylates which derive from saturated alcohols, such as methyl (meth)acrylate, ethyl (meth)acrylate, n-propyl (meth)acrylate, isopropyl (meth)acrylate, n-butyl (meth)acrylate, tert-butyl (meth)acrylate, pentyl (meth)acrylate, hexyl (meth)acrylate, 2-ethylhexyl (meth)acrylate, heptyl (meth)acrylate, 2-tert-butylheptyl (meth)acrylate, octyl (meth)acrylate, 3-isopropylheptyl (meth)acrylate, nonyl (meth)acrylate, decyl (meth)acrylate, undecyl (meth)acrylate, 5-methylundecyl (meth)acrylate, dodecyl (meth)acrylate, 2-methyldodecyl (meth)acrylate, tridecyl (meth)-acrylate, 5-methyltridecyl (meth)acrylate, tetradecyl (meth)acrylate, pentadecyl (meth)acrylate, hexadecyl (meth)acrylate, 2-methylhexadecyl (meth)acrylate, heptadecyl (meth)acrylate, 5-isopropylheptadecyl (meth)acrylate, 4-tert-butyloctadecyl (meth)acrylate, 5-ethyloctadecyl (meth)acrylate, 3-isopropyloctadecyl (meth)acrylate, octadecyl (meth)acrylate, nonadecyl (meth)acrylate, eicosyl (meth)acrylate, cetyleicosyl (meth)acrylate, stearyleicosyl (meth)acrylate, docosyl (meth)acrylate and/or eicosyltetratriacontyl (meth)-acrylate;

(meth)acrylates which derive from unsaturated alcohols, for example 2-propynyl (meth)acrylate, allyl (meth)acrylate, vinyl (meth)acrylate, oleyl (meth)acrylate; cycloalkyl (meth)acrylates such as cyclopentyl (meth)acrylate, 3-vinylcyclohexyl (meth)acrylate.

Examples of vinyl esters having 1 to 30 carbon atoms in the acyl group include vinyl formate, vinyl acetate, vinyl propionate, vinyl butyrate. Preferred vinyl esters comprise 2 to 9, more preferably 2 to 5 carbon atoms in the acyl group. The acyl group here may be linear or branched.

Examples of vinyl ethers having 1 to 30 carbon atoms in the alcohol group include vinyl methyl ether, vinyl ethyl ether, vinyl propyl ether, vinyl butyl ether. Preferred vinyl ethers comprise 1 to 8, more preferably 1 to 4 carbon atoms in the alcohol group. The alcohol group here may be linear or branched.

The notation “(di)ester” means that monoesters, diesters and mixtures of esters, especially of fumaric acid and/or of maleic acid, may be used. The (di)alkyl fumarates having 1 to 30 carbon atoms in the alcohol group include monomethyl fumarate, dimethyl fumarate, monoethyl fumarate, diethyl fumarate, methyl ethyl fumarate, monobutyl fumarate, dibutyl fumarate, dipentyl fumarate and dihexyl fumarate. Preferred (di)alkyl fumarates comprise 1 to 8, more preferably 1 to 4 carbon atoms in the alcohol group. The alcohol group here may be linear or branched.

The (di)alkyl maleates having 1 to 30 carbon atoms in the alcohol group include monomethyl maleate, dimethyl maleate, monoethyl maleate, diethyl maleate, methyl ethyl maleate, monobutyl maleate, dibutyl maleate. Preferred (di)alkyl maleates comprise 1 to 8, more preferably 1 to 4 carbon atoms in the alcohol group. The alcohol group here may be linear or branched.

Surprising advantages with regard to effectiveness as antifatigue additives in lubricants can be achieved especially with comb polymers having repeat units derived from dispersing monomers.

Dispersing monomers have been used for some time for functionalization of polymeric additives in lubricant oils, and are therefore known to those skilled in the art (cf. R. M. Mortier, S. T. Orszulik (eds.): “Chemistry and Technology of Lubricants”, Blackie Academic & Professional, London, 2nd ed. 1997). Appropriately, it is possible to use especially heterocyclic vinyl compounds and/or ethylenically unsaturated, polar ester compounds of the formula (I)

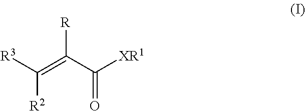

in which R is hydrogen or methyl, X is oxygen, sulfur or an amino group of the formula —NH— or —NR^{a}— in which R^{a} is an alkyl radical having 1 to 10 and preferably 1 to 4 carbon atoms, R¹ is a radical comprising 2 to 50, especially 2 to 30 and preferably 2 to 20 carbon atoms and has at least one heteroatom, preferably at least two heteroatoms, R² and R³ are each independently hydrogen or a group of the formula —COX′R^{1′} in which X′ is oxygen or an amino group of the formula —NH— or —NR^{a′}— in which R^{a′} is an alkyl radical having 1 to 10 and preferably 1 to 4 carbon atoms, and R^{1′} is a radical comprising 1 to 50, preferably 1 to 30 and more preferably 1 to 15 carbon atoms, as dispersing monomers.

The expression “radical comprising 2 to 50 carbon” denotes radicals of organic compounds having 2 to 50 carbon atoms. Similar definitions apply for corresponding terms. It encompasses aromatic and heteroaromatic groups, and alkyl, cycloalkyl, alkoxy, cycloalkoxy, alkenyl, alkanoyl, alkoxycarbonyl groups, and also heteroaliphatic groups. The groups mentioned may be branched or unbranched. In addition, these groups may have customary substituents. Substituents are, for example, linear and branched alkyl groups having 1 to 6 carbon atoms, for example methyl, ethyl, propyl, butyl, pentyl, 2-methylbutyl or hexyl; cycloalkyl groups, for example cyclopentyl and cyclohexyl; aromatic groups such as phenyl or naphthyl; amino groups, hydroxyl groups, ether groups, ester groups and halides.

According to the invention, aromatic groups denote radicals of mono- or polycyclic aromatic compounds having preferably 6 to 20 and especially 6 to 12 carbon atoms. Heteroaromatic groups denote aryl radicals in which at least one CH group has been replaced by N and/or at least two adjacent CH groups have been replaced by S, NH or O, heteroaromatic groups having 3 to 19 carbon atoms.

Aromatic or heteroaromatic groups preferred in accordance with the invention derive from benzene, naphthalene, biphenyl, diphenyl ether, diphenylmethane, diphenyldimethylmethane, bisphenone, diphenyl sulfone, thiophene, furan, pyrrole, thiazole, oxazole, imidazole, isothiazole, isoxazole, pyrazole, 1,3,4-oxadiazole, 2,5-diphenyl-1,3,4-oxadiazole, 1,3,4-thiadiazole, 1,3,4-triazole, 2,5-diphenyl-1,3,4-triazole, 1,2,5-triphenyl-1,3,4-triazole, 1,2,4-oxadiazole, 1,2,4-thiadiazole, 1,2,4-triazole, 1,2,3-triazole, 1,2,3,4-tetrazole, benzo[b]thiophene, benzo[b]furan, indole, benzo[c]thiophene, benzo[c]furan, isoindole, benzoxazole, benzothiazole, benzimidazole, benzisoxazole, benzisothiazole, benzopyrazole, benzothiadiazole, benzotriazole, dibenzofuran, dibenzothiophene, carbazole, pyridine, bipyridine, pyrazine, pyrazole, pyrimidine, pyridazine, 1,3,5-triazine, 1,2,4-triazine, 1,2,4,5-triazine, tetrazine, quinoline, isoquinoline, quinoxaline, quinazoline, cinnoline, 1,8-naphthyridine, 1,5-naphthyridine, 1,6-naphthyridine, 1,7-naphthyridine, phthalazine, pyridopyrimidine, purine, pteridine or quinolizine, 4H-quinolizine, diphenyl ether, anthracene, benzopyrrole, benzoxathiadiazole, benzoxadiazole, benzopyridine, benzopyrazine, benzopyrazidine, benzopyrimidine, benzotriazine, indolizine, pyridopyridine, imidazopyrimidine, pyrazinopyrimidine, carbazole, acridine, phenazine, benzoquinoline, phenoxazine, phenothiazine, acridizine, benzopteridine, phenanthroline and phenanthrene, each of which may also optionally be substituted.

The preferred alkyl groups include the methyl, ethyl, propyl, isopropyl, 1-butyl, 2-butyl, 2-methylpropyl, tert-butyl radical, pentyl, 2-methylbutyl, 1,1-dimethylpropyl, hexyl, heptyl, octyl, 1,1,3,3-tetramethylbutyl, nonyl, 1-decyl, 2-decyl, undecyl, dodecyl, pentadecyl and the eicosyl group.

The preferred cycloalkyl groups include the cyclopropyl, cyclobutyl, cyclopentyl, cyclohexyl, cycloheptyl and the cyclooctyl group, each of which is optionally substituted with branched or unbranched alkyl groups.

The preferred alkanoyl groups include the formyl, acetyl, propionyl, 2-methylpropionyl, butyryl, valeroyl, pivaloyl, hexanoyl, decanoyl and the dodecanoyl group.

The preferred alkoxycarbonyl groups include the methoxycarbonyl, ethoxycarbonyl, propoxycarbonyl, butoxycarbonyl, tert-butoxycarbonyl group, hexyloxycarbonyl, 2-methylhexyloxycarbonyl, decyloxycarbonyl or dodecyloxycarbonyl group.

The preferred alkoxy groups include alkoxy groups whose hydrocarbon radical is one of the aforementioned preferred alkyl groups.

The preferred cycloalkoxy groups include cycloalkoxy groups whose hydrocarbon radical is one of the aforementioned preferred cycloalkyl groups.

The preferred heteroatoms which are present in the R¹ radical include oxygen, nitrogen, sulfur, boron, silicon and phosphorus, preference being given to oxygen and nitrogen.

The R¹ radical comprises at least one heteroatom, preferably at least two and more preferably at least three heteroatoms.

The R¹ radical in ester compounds of the formula (I) preferably has at least 2 different heteroatoms. In this case, the R¹ radical in at least one of the ester compounds of the formula (I) may comprise at least one nitrogen atom and at least one oxygen atom.

Examples of ethylenically unsaturated, polar ester compounds of the formula (I) include aminoalkyl (meth)acrylates, aminoalkyl(meth)acrylamides, hydroxyalkyl (meth)acrylates, heterocyclic (meth)acrylates and/or carbonyl-containing (meth)acrylates.

The hydroxyalkyl (meth)acrylates include 2-hydroxypropyl (meth)acrylate, 3,4-dihydroxybutyl (meth)acrylate, 2-hydroxyethyl (meth)acrylate, 3-hydroxypropyl (meth)acrylate, 2,5-dimethyl-1,6-hexanediol (meth)acrylate and 1,10-decanediol (meth)acrylate.

Appropriate carbonyl-containing (meth)acrylates include, for example,
2-carboxyethyl (meth)acrylate, carboxymethyl (meth)acrylate,
oxazolidinylethyl (meth)acrylate,
N-(methacryloyloxy)formamide,
acetonyl (meth)acrylate,
mono-2-(meth)acryloyloxyethyl succinate,
N-(meth)acryloylmorpholine,
N-(meth)acryloyl-2-pyrrolidinone,
N-(2-(meth)acryloyloxyethyl)-2-pyrrolidinone,
N-(3-(meth)acryloyloxypropyl)-2-pyrrolidinone,
N-(2-(meth)acryloyloxypentadecyl)-2-pyrrolidinone,
N-(3-(meth)acryloyloxyheptadecyl)-2-pyrrolidinone and N-(2-(meth)acryloyloxyethyl)ethyleneurea.

2-Acetoacetoxyethyl (meth)acrylate

The heterocyclic (meth)acrylates include 2-(1-imidazolyl)ethyl (meth)acrylate,
2-(4-morpholinyl)ethyl (meth)acrylate,
1-(2-methacryloyloxyethyl)-2-pyrrolidone,
N-methacryloylmorpholine,
N-methacryloyl-2-pyrrolidinone,
N-(2-methacryloyloxyethyl)-2-pyrrolidinone,
N-(3-methacryloyloxypropyl)-2-pyrrolidinone.

The aminoalkyl (meth)acrylates include especially N,N-dimethylaminoethyl (meth)acrylate,
N,N-dimethylaminopropyl (meth)acrylate,
N,N-diethylaminopentyl (meth)acrylate,
N,N-dibutylaminohexadecyl (meth)acrylate.

Aminoalkyl(meth)acrylamides can also be used as dispersing monomers, such as N,N-dimethylaminopropyl(meth)acrylamide.

In addition, it is possible to use phosphorus-, boron- and/or silicon-containing (meth)acrylates as dispersing monomers, such as 2-(dimethylphosphato)propyl (meth)acrylate, 2-(ethylenephosphito)propyl (meth)acrylate, dimethylphosphinomethyl (meth)acrylate, dimethylphosphonoethyl (meth)acrylate, diethyl(meth)acryloyl phosphonate, dipropyl(meth)acryloyl phosphate, 2-(dibutylphosphono)ethyl (meth)acrylate, 2,3-butylene(meth)acryloylethyl borate, methyldiethoxy(meth)acryloylethoxysilane, diethylphosphatoethyl (meth)acrylate.

The preferred heterocyclic vinyl compounds include 2-vinylpyridine, 3-vinylpyridine, 4-vinylpyridine, 2-methyl-5-vinylpyridine, 3-ethyl-4-vinylpyridine, 2,3-dimethyl-5-vinylpyridine, vinylpyrimidine, vinylpiperidine, 9-vinylcarbazole, 3-vinylcarbazole, 4-vinylcarbazole, 1-vinylimidazole, N-vinylimidazole, 2-methyl-1-vinylimidazole, N-vinylpyrrolidone, 2-vinylpyrrolidone, N-vinylpyrrolidine, 3-vinylpyrrolidine, N-vinylcaprolactam, N-vinylbutyrolactam, vinyloxolane, vinylfuran, vinylthiophene, vinylthiolane, vinylthiazoles and hydrogenated vinylthiazoles, vinyloxazoles and hydrogenated vinyloxazoles, particular preference being given to using N-vinylimidazole and N-vinylpyrrolidone for functionalization.

The monomers detailed above can be used individually or as a mixture.

Of particular interest are especially comb polymers which are obtained using 2-hydroxypropyl methacrylate, 2-hydroxyethyl methacrylate, mono-2-methacryloyloxyethyl succinate, N-(2-methacryloyloxyethyl)ethyleneurea, 2-acetoacetoxyethyl methacrylate, 2-(4-morpholinyl)ethyl methacrylate, dimethylaminodiglycol methacrylate, dimethylaminoethyl methacrylate and/or dimethylaminopropylmethacrylamide. Particular preference is given especially to comb polymers which have repeat units of the above-described aminoalkyl(meth)acrylamides, especially dimethylaminopropyl(meth)acrylamide.

The aforementioned ethylenically unsaturated monomers can be used individually or as mixtures. It is additionally possible to vary the monomer composition during the polymerization of the main chain, in order to obtain defined structures, for example block copolymers or graft polymers.

In a particular aspect of the present invention, the comb polymer, especially the main chain of the comb polymer, may have a glass transition temperature in the range of −60 to 110° C., preferably in the range of −30 to 100° C., more preferably in the range of 0 to 90° C. and most preferably in the range of 20 to 80° C. The glass transition temperature is determined by DSC. The glass transition temperature can be estimated via the glass transition temperature of the corresponding homopolymers, taking account of the proportions of the repeat units in the main chain.

The comb polymer has preferably 10 to 80% by weight, more preferably 30 to 70% by weight, of repeat units derived from polyolefin-based macromonomers, based on the total weight of repeat units. In addition to the repeat units, polymers generally also comprise start groups and end groups which can form through initiation reactions and termination reactions. The polydispersity of the comb polymers is obvious to the person skilled in the art. These data are therefore based on a mean value over all comb polymers.

Comb polymers of particular interest include those which preferably have a weight-average molecular weight M_{w} in the range from 20 000 to 1 000 000 g/mol, more preferably 50 000 to 500 000 g/mol and most preferably 150 000 to 450 000 g/mol.

The number-average molecular weight Mₙ may preferably be in the range from 20 000 to 800 000 g/mol, more preferably 40 000 to 200 000 g/mol and most preferably 50 000 to 150 000 g/mol.

Comb polymers which are additionally appropriate to the purpose are those whose polydispersity index M_{w}/Mₙ is in the range from 1 to 5, more preferably in the range from 2.5 to 4.5. The number-average and the weight-average molecular weight can be determined by known processes, for example gel permeation chromatography (GPC). This process is described in detail in WO 2007/025837, filed Aug. 4, 2006, at the European Patent Office with application number PCT/EP2006/065060, and in WO 2007/03238, filed Apr. 7, 2006, at the European Patent Office with application number PCT/EP2007/003213, the processes detailed therein for determination of the molecular weight being incorporated into this application for the purposes of disclosure.

In a particular embodiment of the present invention, the comb polymers can be modified especially by grafting with dispersing monomers. Dispersing monomers are understood especially to mean monomers with functional groups, through which particles, especially soot particles, can be kept in solution. These include especially the above-described monomers derived from oxygen- and nitrogen-functionalized monomers, especially from heterocyclic vinyl compounds.

The inventive comb polymers can be prepared in various ways. A preferred process consists in the free-radical copolymerization, which is known per se, of low molecular weight monomers and macromolecular monomers.

For instance, these polymers can be effected especially by free-radical polymerization, and also related processes for controlled free-radical polymerization, for example ATRP (=Atom Transfer Radical Polymerization) or RAFT (=Reversible Addition Fragmentation Chain Transfer).

Customary free-radical polymerization is explained, inter alia, in Ullmann's Encyclopedia of Industrial Chemistry, Sixth Edition. In general, a polymerization initiator and optionally a chain transferer are used for this purpose.

The usable initiators include the azo initiators well known in the technical field, such as AIBN and 1,1-azo-biscyclohexanecarbonitrile, and also peroxy compounds such as methyl ethyl ketone peroxide, acetylacetone peroxide, dilauryl peroxide, tert-butyl per-2-ethylhexanoate, ketone peroxide, tert-butyl peroctoate, methyl isobutyl ketone peroxide, cyclohexanone peroxide, dibenzoyl peroxide, tert-butyl peroxybenzoate, tert-butyl peroxyisopropylcarbonate, 2,5-bis(2-ethylhexanoylperoxy)-2,5-dimethylhexane, tert-butyl peroxy-2-ethylhexanoate, tert-butyl peroxy-3,5,5-trimethylhexanoate, dicumyl peroxide, 1,1-bis(tert-butylperoxy)cyclohexane, 1,1-bis(tert-butylperoxy)-3,3,5-trimethylcyclohexane, cumyl hydroperoxide, tert-butyl hydroperoxide, bis(4-tert-butylcyclohexyl) peroxydicarbonate, mixtures of two or more of the aforementioned compounds with one another, and also mixtures of the aforementioned compounds with compounds which have not been mentioned and can likewise form free radicals. Suitable chain transferers are especially oil-soluble mercaptans, for example n-dodecyl mercaptan or 2-mercaptoethanol, or else chain transferers from the class of the terpenes, for example terpinolene.

The ATRP process is known per se. It is assumed that this is a “living” free-radical polymerization, without any intention that the description of the mechanism should impose a restriction. In these processes, a transition metal compound is reacted with a compound which has a transferable atom group. At the same time, the transferable atom group is transferred to the transition metal compound, which oxidizes the metal.

This reaction forms a free radical which adds onto ethylenic groups. However, the transfer of the atom group to the transition metal compound is reversible, so that the atom group is transferred back to the growing polymer chain, which forms a controlled polymerization system. The structure of the polymer, the molecular weight and the molecular weight distribution can be controlled correspondingly.

This reaction regime is described, for example, by J-S. Wang, et al., J. Am. Chem. Soc., vol. 117, p. 5614-5615 (1995), by Matyjaszewski, Macromolecules, vol. 28, p. 7901-7910 (1995). In addition, the patent applications WO 96/30421, WO 97/47661, WO 97/18247, WO 98/40415 and WO 99/10387 disclose variants of the ATRP explained above.

In addition, the inventive polymers may be obtained, for example, also via RAFT methods. This process is presented in detail, for example, in WO 98/01478 and WO 2004/083169.

The polymerization can be carried out at standard pressure, reduced pressure or elevated pressure. The polymerization temperature too is uncritical. However, it is generally in the range of −20°-200° C., preferably 50°-150° C. and more preferably 80°-130° C.

The polymerization may be carried out with or without solvent. The term “solvent” is to be understood here in a broad sense. The solvent is selected according to the polarity of the monomers used, preference being given to using 100N oil, relatively light gas oil and/or aromatic hydrocarbons, for example toluene or xylene.

The low molecular weight monomers to be used to prepare the inventive comb polymers in a free-radical copolymerization are generally commercially available.

Macromonomers usable in accordance with the invention have preferably exactly one free-radically polymerizable double bond, which is preferably terminal.

The double bond here may be present as a result of the preparation of the macromonomers. For example, a cationic polymerization of isobutylene forms a polyisobutylene (PIB) which has a terminal double bond.

In addition, functionalized polyolefinic groups can be converted to a macromonomer by suitable reactions.

For example, macroalcohols and/or macroamines based on polyolefins can be subjected to a transesterification or aminolysis with low molecular weight monomers which have at least one unsaturated ester group, for example methyl (meth)acrylate or ethyl (meth)acrylate.

This transesterification is widely known. For example, a heterogeneous catalyst system can be used for this purpose, such as lithium hydroxide/calcium oxide mixture (LiOH/Ca0), pure lithium hydroxide (LiOH), lithium methoxide (LiOMe) or sodium methoxide (NaOMe), or a homogeneous catalyst system, such as isopropyl titanate (Ti(OiPr)₄) or dioctyltin oxide (Sn(Oct)₂O).

The reaction is an equilibrium reaction. The low molecular weight alcohol released is therefore typically removed, for example, by distillation.

In addition, these macromonomers can be obtained by a direct esterification or direct amidation proceeding, for example, from methacrylic acid or methacrylic anhydride, preferably with acidic catalysis by p-toluenesulfonic acid or methanesulfonic acid or from free methacrylic acid by the DCC method (dicyclohexylcarbodiimide).

In addition, the present alcohol or the amide can be converted to a macromonomer by reaction with an acid chloride, such as (meth)acryloyl chloride.

In addition, it is also possible to prepare a macroalcohol via the reaction of the terminal PIB double bond, as forms in cationically polymerized PIB, with maleic anhydride (ene reaction) and subsequent reaction with an α,ω-amino alcohol.

Moreover, suitable macromonomers can be obtained by reacting a terminal PIB double bond with methacrylic acid or by a Friedel-Crafts alkylation of the PIB double bond onto styrene.

In the preparations of the macromonomers detailed above, preference is given to using polymerization inhibitors, for example the 4-hydroxy-2,2,6,6-tetramethylpiperidine oxyl radical and/or hydroquinone monomethyl ether.

The macroalcohols and/or macroamines which are based on polyolefins and are to be used for the reactions detailed above can be prepared in a known manner.

In addition, some of these macroalcohols and/or macroamines are commercially available.

The commercially available macroamines include, for example, Kerocom® PIBA 03. Kerocom® PIBA 03 is a polyisobutylene (PIB) of Mₙ=1000 g/mol which has been NH₂-functionalized to an extent of about 75% by weight and is supplied as a concentrate of about 65% by weight in aliphatic hydrocarbons by BASF AG (Ludwigshafen, Germany).

A further product is Kraton Liquid® L-1203, a hydrogenated polybutadiene which has been OH-functionalized to an extent of about 98% by weight (also known as olefin copolymer OCP) and has about 50% each of 1,2 repeat units and 1,4 repeat units of Mₙ=4200 g/mol, from Kraton Polymers GmbH (Eschborn, Germany).

Further suppliers of suitable macroalcohols based on hydrogenated polybutadiene are Cray Valley (Paris), a daughter company of Total (Paris), and the Sartomer Company (Exton/Pa./USA).

The preparation of macroamines is described, for example, in EP 0 244 616 to BASF AG. The macroamines are prepared via hydroformylation and amination, preferably of polyisobutylene. Polyisobutylene offers the advantage of exhibiting no crystallization at low temperatures.

Advantageous macroalcohols may additionally be prepared according to the known patents to BASF AG, either via hydroboration (WO 2004/067583) of highly reactive polyisobutylene HR-PIB (EP 0 628 575), which contains an elevated proportion of terminal α-double bonds, or by hydroformylation followed by hydrogenation (EP 0 277 345). Compared to hydroformylation and hydrogenation, hydroboration affords higher alcohol functionalities.

Preferred macroalcohols based on hydrogenated polybutadienes can be obtained according to GB 2270317 to Shell International Research Maatschappij. A high proportion of 1,2 repeat units of about 60% and more can lead to significantly lower crystallization temperatures.

Some of the above-described macromonomers are also commercially available, for example Kraton Liquid® L-1253, which is produced from Kraton Liquid® L-1203 and is a hydrogenated polybutadiene which has been methacrylate-functionalized to an extent of about 96% by weight and has about 50% each of 1,2 repeat units and 1,4 repeat units, from Kraton Polymers GmbH (Eschborn, Germany).

Kraton® L-1253 was synthesized according to GB 2270317 to Shell International Research Maatschappij.

Macromonomers based on polyolefins and their preparation are also detailed in EP 0 621 293 and EP 0 699 694.

In addition to an above-described free-radical copolymerization of macromonomers and low molecular weight monomers, the inventive comb polymers can be obtained by polymer-analogous reactions.

In these reactions, a polymer is first prepared in a known manner from low molecular weight monomers and is then converted. In this case, the backbone of a comb polymer can be synthesized from a reactive monomer such as maleic anhydride, methacrylic acid or else glycidyl methacrylate and other unreactive short-chain backbone monomers. In this case, the above-described initiator systems, such as t-butyl perbenzoate or t-butyl per-2-ethylhexanoate, and regulators such as n-dodecyl mercaptan can be used.

In a further step, for example in an alcoholysis or aminolysis, the side chains, which are also referred to as arms, can be generated. In this reaction, the macroalcohols and/or macroamines detailed above can be used.

The reaction of the initially formed backbone polymer with macroalcohols and/or macroamines corresponds essentially to the reactions detailed above of the macroalcohols and/or macroamines with low molecular weight compounds.

For example, the macroalcohols and/or macroamines can be converted to the inventive comb polymers in grafting reactions known per se, for example onto the present maleic anhydride or methacrylic acid functionalities in the backbone polymer with catalysis, for example, by p-toluenesulfonic acid or methanesulfonic acid to give esters, amides or imides. Addition of low molecular weight alcohols and/or amines, such as n-butanol or N-(3-aminopropyl)morpholine, allows this polymer-analogous reaction to be conducted to complete conversions, especially in the case of maleic anhydride backbones.

In the case of glycidyl functionalities in the backbone, an addition of the macroalcohol and/or of the macroamine can be performed so as to form comb polymers.

In addition, the macroalcohols and/or the macroamines can be converted by a polymer-analogous alcoholysis or aminolysis with a backbone which contains short-chain ester functionalities in order to generate comb polymers.

In addition to the reaction of the backbone polymer with macromolecular compounds, suitably functionalized polymers which have been obtained by conversion of low molecular weight monomers can be reacted with further low molecular weight monomers to form comb polymers. In this case, the initially prepared backbone polymer has a plurality of functionalities which serve as initiators of multiple graft polymerizations.

For instance, a multiple cationic polymerization of i-butene can be initiated, which leads to comb polymers with polyolefin side arms. Suitable processes for such graft copolymerizations are also the ATRP and/or RAFT processes detailed above in order to obtain comb polymers with a defined architecture.

The comb polymers for use in accordance with the present invention preferably have, in a particular aspect of the present invention, a low proportion of olefinic double bonds. The iodine number is preferably less than or equal to 0.2 g per g of comb polymer, more preferably less than or equal to 0.1 g per g of comb polymer. This proportion can be determined according to DIN 53241 after drawing off carrier oil and low molecular weight residual monomers at 180° C. under reduced pressure for 24 hours.

Particularly effective comb polymers comprise at least 10% by weight of repeat units derived from styrene monomers having 8 to 17 carbon atoms, and at least 5% by weight of repeat units derived from alkyl (meth)acrylates having 1 to 6 carbon atoms. The figures here are based on the total weight of repeat units in the comb polymer. These figures result from the weight ratios of the monomers in the preparation of the comb polymer. In addition, these comb polymers feature a polarity of at least 30% THF. These comb polymers are novel and therefore likewise form part of the subject matter of the present invention. These comb polymers are preferably effective as viscosity index improvers and are also referred to hereinafter as comb polymers with VI action. These comb polymers are especially notable for multifunctionality with relatively high stressability and durability.

In a preferred embodiment, the comb polymer with VI action may have 30 to 60% by weight, more preferably 35 to 50% by weight, of repeat units derived from polyolefin-based macromonomers with a molecular weight of at least 500 g/mol. These figures are based here on the total weight of repeat units of the comb polymer. These figures result from the weight ratios of the monomers in the preparation of the comb polymer. These monomers have been detailed above, and reference is made to these details.

Styrene monomers and alkyl (meth)acrylates having 1 to 6 carbon atoms have been detailed above, and n-butyl methacrylate can be used with particular preference for preparation of the inventive viscosity index-improving comb polymers with VI action.

Particular advantages with regard to effectiveness as an antifatigue additive can be achieved especially by comb polymers with VI action which have repeat units derived from styrene and repeat units derived from n-butyl methacrylate. Of particular interest are especially comb polymers with VI action in which the weight ratio of repeat units derived from styrene to the repeat units derived from n-butyl methacrylate is in the range from 4:1 to 1.5:1.

A comb polymer with VI action according to the present invention preferably has repeat units derived from dispersing monomers. These monomers have been detailed above, particular preference being given to aminoalkyl-(meth)acrylamides. The proportion of repeat units derived from dispersing monomers is preferably 1 to 8% by weight, more preferably 2 to 4% by weight. These figures are based here on the total weight of repeat units in the comb polymer. These figures result from the weight ratios of the monomers in the preparation of the comb polymer.

Advantageously, the weight ratio of repeat units derived from polyolefin-based macromonomers to the repeat units derived from dispersing monomers in the comb polymer with VI action is preferably in the range from 30:1 to 8:1, more preferably in the range from 25:1 to 10:1.

In a particular modification of the present invention, the ratio of the number-average molecular weight Mₙ of the polyolefin-based macromonomer to the number-average molecular weight Mₙ of the comb polymer with VI action is in the range from 1:10 to 1:50, more preferably 1:15 to 1:45.

The comb polymer with VI action has a polarity of at least 30% THF, preferably at least 80% THF and more preferably at least 100% THF. The polarity of the polymers is determined by the elution characteristics thereof from defined HPLC column material. This involves dissolving the comb polymer in i-octane (=nonpolar solvent) and applying it to a CN-functionalized silica column. Subsequently, the eluent composition is changed continuously by adding THF (tetrahydrofuran; a polar solvent) until the eluent is strong enough to desorb the polymer applied again. The polarity accordingly corresponds to the proportion by volume of THF in the eluent needed for desorption (% by volume of THF proceeding from 100% by volume of i-octane). A polarity of at least 100% THF means that the adhesion of the polymer on a CN-functionalized silica column is so great that the polymer cannot be eluted with THF. Further details for determination of the polarity are given in the examples.

The polarity can be adjusted especially via the use of dispersing monomers, the method of incorporation of the dispersing monomers, the proportion and the molecular weight of the macromonomers, and the molecular weight of the comb polymer. High polarities can be achieved especially by high molecular weights of the macromonomers and a high proportion of dispersing monomers.

In this context, comb polymers with randomly incorporated repeat units derived from dispersing monomers are superior to comb polymers onto which dispersing monomers have been grafted. Further valuable information is available from the examples appended.

The limiting viscosity of the comb polymer with VI action is preferably in the range from 40 to 100 ml/g, more preferably in the range from 50 to 90 ml/g and especially preferably in the range from 55 to 70 ml/g.

The limiting viscosity is determined in chloroform as a solvent at 20° C. with the aid of an Ubbelohde capillary.

The size of the Ubbelohde capillary is selected such that the run times of the pure solvent and of the polymer-containing solutions are between 200 and 300 seconds. The mass concentration p in g/m¹ is selected such that the run time of the polymer-containing solution exceeds that of the pure solvent by not more than 10%. The limiting viscosity can be calculated from the run times of the polymer-containing solution and the solvent, and from the mass concentration of the polymer in the solution, as follows:

$$Limiting viscosity = \frac{\sqrt{2}}{β} * \sqrt{{η}_{rel} - ln ( {η}_{spec} )} where$$

$${η}_{rel} = ( {t}_{polymer solution} - {t}_{solvent} ) / {t}_{solvent}$$

$${η}_{spec} = {t}_{polymer solution} {/}_{solvent} \\ t = run time in seconds$$

Surprising advantages are achieved by comb polymers with VI action which preferably have repeat units derived from methyl methacrylate and repeat units derived from alkyl (meth)acrylates having 8 to 30 carbon atoms in the alcohol group.

In a further aspect, the present invention provides novel, particularly shear-stable antifatigue additives which are therefore durable in use, and likewise form part of the subject matter of the present invention.

These shear-stable comb polymers have repeat units derived from alkyl (meth)acrylates having 8 to 30 carbon atoms in the alcohol group, a polarity of at least 50% THF and a limiting viscosity in the range from 20 to 50 ml/g. These comb polymers are notable especially for particularly high stressability and durability, and they exhibit high compatibility with further additives, for example VI improvers.

The polarity of the present shear-stable comb polymers is at least 50% THF, more preferably at least 80% THF and most preferably 100% THF. The method for determining the polarity has been detailed above. It should additionally be emphasized that this depends on the proportion and the type of the dispersing monomers, the proportion and the molecular weight of the macromonomers, and the molecular weight of the comb polymers, and the relations detailed above also apply in relation to the shear-stable comb polymers and valuable information can be found in the examples.

Alkyl (meth)acrylates having 8 to 30 carbon atoms in the alcohol group have been detailed above, and reference is made to these remarks. The proportion of repeat units derived from alkyl (meth)acrylates having 8 to 30 carbon atoms in shear-stable comb polymers is preferably at least 5% by weight, more preferably at least 10% by weight and most preferably at least 15% by weight. These figures are based here on the total weight of repeat units of the comb polymer. These figures result from the weight ratios of the monomers in the preparation of the comb polymer.

In a preferred embodiment, a shear-stable comb polymer may have 30 to 80% by weight, more preferably 40 to 70% by weight, of repeat units derived from polyolefin-based macromonomers with a molecular weight of at least 500 g/mol. These figures are based here on the total weight of repeat units in the comb polymer. These figures result from the weight ratios of the monomers in the preparation of the comb polymer. These monomers have been detailed above, and reference may be made to these remarks.

A shear-stable comb polymer according to the present invention may preferably have repeat units derived from dispersing monomers. These monomers have been detailed above, and particular preference is given to aminoalkyl-(meth)acrylamides. The proportion of repeat units derived from dispersing monomers in shear-stable comb polymers of the present invention is preferably at least 5% by weight, more preferably at least 10% by weight and most preferably at least 15% by weight. The upper limit results especially from the oil solubility of the shear-stable comb polymers, the proportion of repeat units derived from dispersing monomers being typically less than 50% by weight, preferably less than 30% by weight. These figures are based here on the total weight of repeat units in the comb polymer. These figures result from the weight ratios of the monomers in the preparation of the comb polymer.

The weight ratio of repeat units derived from alkyl (meth)acrylates having 8 to 30 carbon atoms in the alcohol group to the repeat units derived from dispersing monomers in the case of shear-stable comb polymers is preferably in the range from 3:1 to 1:2, more preferably in the range from 2:1 to 1:1.5.

Preference is therefore given to shear-stable comb polymers wherein the weight ratio of repeat units derived from polyolefin-based macromonomers to the repeat units derived from dispersing monomers is in the range from 8:1 to 1:1, more preferably from 6:1 to 2:1.

Shear-stable comb polymers preferably have repeat units derived from methyl methacrylate and repeat units derived from n-butyl methacrylate.

The shear-stable comb polymer has a limiting viscosity in the range from 15 to 50 ml/g, preferably 20 to 40 and most preferably 22 to 35. The limiting viscosity is determined by the method detailed above at 20° C. in chloroform as a solvent with the aid of a Ubbelohde capillary.

Additionally of particular interest are shear-stable comb polymers with a ratio of the number-average molecular weight Mₙ of the polyolefin-based macromonomer to the number-average molecular weight Mₙ of the comb polymer in the range from 1:2 to 1:6, more preferably 1:3 to 1:5.

The inventive comb polymer can preferably be used in a lubricant oil composition. A lubricant oil composition comprises at least one lubricant oil.

The lubricant oils include especially mineral oils, synthetic oils and natural oils.

Mineral oils are known per se and commercially available. They are generally obtained from mineral oil or crude oil by distillation and/or refining and optionally further purification and finishing processes, the term “mineral oil” including in particular the higher-boiling fractions of crude or mineral oil. In general, the boiling point of mineral oil is higher than 200° C., preferably higher than 300° C., at 5000 Pa. The production by low-temperature carbonization of shale oil, coking of bituminous coal, distillation of brown coal with exclusion of air, and also hydrogenation of bituminous or brown coal is likewise possible. Accordingly, mineral oils have, depending on their origin, different proportions of aromatic, cyclic, branched and linear hydrocarbons.

In general, a distinction is drawn between paraffin-base, naphthenic and aromatic fractions in crude oils or mineral oils, in which the term “paraffin-base fraction” represents longer-chain or highly branched isoalkanes, and “naphthenic fraction” represents cycloalkanes. In addition, mineral oils, depending on their origin and finishing, have different fractions of n-alkanes, isoalkanes having a low degree of branching, known as mono-methyl-branched paraffins, and compounds having heteroatoms, in particular O, N and/or S, to which a degree of polar properties are attributed. However, the assignment is difficult, since individual alkane molecules may have both long-chain branched groups and cycloalkane radicals, and aromatic parts. For the purposes of the present invention, the assignment can be effected to DIN 51 378, for example. Polar fractions can also be determined to ASTM D 2007.

The proportion of n-alkanes in preferred mineral oils is less than 3% by weight, the fraction of O-, N- and/or S-containing compounds less than 6% by weight. The fraction of the aromatics and of the mono-methyl-branched paraffins is generally in each case in the range from 0 to 40% by weight. In one interesting aspect, mineral oil comprises mainly naphthenic and paraffin-base alkanes which have generally more than 13, preferably more than 18 and most preferably more than 20 carbon atoms. The fraction of these compounds is generally ≧60% by weight, preferably ≧80% by weight, without any intention that this should impose a restriction. A preferred mineral oil contains 0.5 to 30% by weight of aromatic fractions, 15 to 40% by weight of naphthenic fractions, 35 to 80% by weight of paraffin-base fractions, up to 3% by weight of n-alkanes and 0.05 to 5% by weight of polar compounds, based in each case on the total weight of the mineral oil.

An analysis of particularly preferred mineral oils, which was effected by means of conventional processes such as urea separation and liquid chromatography on silica gel, shows, for example, the following constituents, the percentages relating to the total weight of the particular mineral oil used:

n-alkanes having approx. 18 to 31 carbon atoms:
0.7-1.0%,
slightly branched alkanes having 18 to 31 carbon atoms:
1.0-8.0%,
aromatics having 14 to 32 carbon atoms: ™0.4-10.7%,
iso- and cycloalkanes having 20 to 32 carbon atoms: 60.7-82.4%,
polar compounds:
0.1-0.8%,
loss:
6.9-19.4%.

An improved class of mineral oils (reduced sulfur content, reduced nitrogen content, higher viscosity index, lower pour point) results from hydrogen treatment of the mineral oils (hydroisomerization, hydrocracking, hydrotreatment, hydrofinishing). In the presence of hydrogen, this essentially reduces aromatic components and builds up naphthenic components.

Valuable information with regard to the analysis of mineral oils and a list of mineral oils which have a different composition can be found, for example, in Ullmann's Encyclopedia of Industrial Chemistry, 5th Edition on CD-ROM, 1997, under “lubricants and related products”.

Synthetic oils include organic esters, for example diesters and polyesters, polyalkylene glycols, polyethers, synthetic hydrocarbons, especially polyolefins, among which preference is given to polyalphaolefins (PAOs), silicone oils and perfluoroalkyl ethers. In addition, it is possible to use synthetic base oils originating from gas to liquid (GTL), coal to liquid (CTL) or biomass to liquid (BTL) processes. They are usually somewhat more expensive than the mineral oils, but have advantages with regard to their performance.

Natural oils are animal or vegetable oils, for example neatsfoot oils or jojoba oils.

Base oils for lubricant oil formulations are divided into groups according to API (American Petroleum Institute). Mineral oils are divided into group I (non-hydrogen-treated) and, depending on the degree of saturation, sulfur content and viscosity index, into groups II and III (both hydrogen-treated). PAOs correspond to group IV. All other base oils are encompassed in group V.

These lubricant oils may also be used as mixtures and are in many cases commercially available.

The concentration of the comb polymer in the lubricant oil composition is preferably in the range of 0.1 to 40% by weight, more preferably in the range of 0.2-20% by weight and most preferably in the range of 0.5-10% by weight, based on the total weight of the composition.

In addition to the components mentioned above, a lubricant oil composition may comprise further additives. Preferred additives may especially be based on a linear polyalkyl (meth)acrylate having 1 to 30 carbon atoms in the alcohol group (PAMA). These additives include DI additives (dispersants, detergents, defoamers, corrosion inhibitors, antioxidants, antiwear and extreme pressure additives, friction modifiers), pour point improvers (more preferably based on polyalkyl (meth)acrylate having 1 to 30 carbon atoms in the alcohol group), and/or dyes.

In addition, the lubricant oil compositions detailed here, as well as the inventive comb polymers, may also be present in mixtures with conventional VI improvers. These include especially hydrogenated styrene-diene copolymers (HSDs, U.S. Pat. No. 4,116,917, U.S. Pat. No. 3,772,196 and U.S. Pat. No. 4,788,316 to Shell Oil Company), especially based on butadiene and isoprene, and also olefin copolymers (OCPs, K. Marsden: “Literature Review of OCP Viscosity Modifiers”, Lubrication Science 1 (1988), 265), especially of the poly(ethylene-co-propylene) type, which may often also be present in N/O-functional form with dispersing action, or PAMAs, which are usually present in N-functional form with advantageous additional properties (boosters) as dispersants, wear protection additives and/or friction modifiers (DE 1 520 696 to Rohm and Haas, WO 2006/007934 to RohMax Additives).

Compilations of VI improvers and pour point improvers for lubricant oils, especially motor oils, are detailed, for example, in T. Mang, W. Dresel (eds.): “Lubricants and Lubrication”, Wiley-VCH, Weinheim 2001, R. M. Mortier, S. T. Orszulik (eds.): “Chemistry and Technology of Lubricants”, Blackie Academic & Professional, London 1992; or J. Bartz: “Additive für Schmierstoffe”, Expert-Verlag, Renningen-Malmsheim 1994.

Appropriate dispersants include poly(isobutylene) derivatives, e.g. poly(isobutylene)succinimides (PIBSIs); ethylene-propylene oligomers with N/O functionalities.

The preferred detergents include metal-containing compounds, for example phenoxides; salicylates; thiophosphonates, especially thiopyrophosphonates, thiophosphonates and phosphonates; sulfonates and carbonates. As metals, these compounds may comprise especially calcium, magnesium and barium. These compounds may be used preferably in neutral or overbased form.

Of particular interest are additionally defoamers, which are in many cases divided into silicone-containing and silicone-free defoamers. The silicone-containing defoamers include linear poly(dimethylsiloxane) and cyclic poly(dimethylsiloxane). The silicone-free defoamers which may be used are in many cases polyethers, for example poly(ethylene glycol) or tributyl phosphate.

In a particular embodiment, the inventive lubricant oil compositions may comprise corrosion inhibitors. These are in many cases divided into antirust additives and metal passivators/deactivators. The antirust additives used may, inter alia, be sulfonates, for example petroleumsulfonates or (in many cases overbased) synthetic alkylbenzenesulfonates, e.g. dinonylnaphthenesulfonate; carboxylic acid derivatives, for example lanolin (wool fat), oxidized paraffins, zinc naphthenates, alkylated succinic acids, 4-nonylphenoxyacetic acid, amides and imides (N-acylsarcosine, imidazoline derivatives); amine-neutralized mono- and dialkyl phosphates; morpholine; dicyclohexylamine or diethanolamine. The metal passivators/deactivators include benzotriazole, tolyltriazole, 2-mercaptobenzothiazole, dialkyl-2,5-dimercapto-1,3,4-thiadiazole; N,N′-disalicylideneethylenediamine, N,N′-disalicylidenepropylenediamine; zinc dialkyldithiophosphates and dialkyl dithiocarbamates.

A further preferred group of additives is that of antioxidants. The antioxidants include, for example, phenols, for example 2,6-di-tert-butylphenol (2,6-DTB), butylated hydroxytoluene (BHT), 2,6-di-tert-butyl-4-methylphenol, 4,4′-methylenebis(2,6-di-tert-butylphenol); aromatic amines, especially alkylated diphenylamines, N-phenyl-1-naphthylamine (PNA), polymeric 2,2,4-trimethyldihydroquinone (TMQ); compounds containing sulfur and phosphorus, for example metal dithiophosphates, e.g. zinc dithiophosphates (ZnDTP), “OOS triesters”=reaction products of dithiophosphoric acid with activated double bonds from olefins, cyclopentadiene, norbornadiene, α-pinene, polybutene, acrylic esters, maleic esters (ashless on combustion); organosulfur compounds, for example dialkyl sulfides, diaryl sulfides, polysulfides, modified thiols, thiophene derivatives, xanthates, thioglycols, thioaldehydes, sulfur-containing carboxylic acids; heterocyclic sulfur/nitrogen compounds, especially dialkyldimercaptothiadiazoles, 2-mercaptobenzimidazoles; zinc and methylene bis(dialkyldithiocarbamate); organophosphorus compounds, for example triaryl and trialkyl phosphites; organocopper compounds and overbased calcium- and magnesium-based phenoxides and salicylates.

The preferred antiwear (AW) and extreme pressure (EP) additives include phosphorus compounds, for example trialkyl phosphates, triaryl phosphates, e.g. tricresyl phosphate, amine-neutralized mono- and dialkyl phosphates, ethoxylated mono- and dialkyl phosphates, phosphites, phosphonates, phosphines; compounds containing sulfur and phosphorus, for example metal dithiophosphates, e.g. zinc C₃₋₁₂dialkyldithiophosphates (ZnDTPs), ammonium dialkyldithiophosphates, antimony dialkyldithiophosphates, molybdenum dialkyldithiophosphates, lead dialkyldithiophosphates, “OOS triesters”=reaction products of dithiophosphoric acid with activated double bonds from olefins, cyclopentadiene, norbornadiene, α-pinene, polybutene, acrylic esters, maleic esters, triphenylphosphorothionate (TPPT); compounds containing sulfur and nitrogen, for example zinc bis(amyl dithiocarbamate) or methylenebis(di-n-butyl dithiocarbamate); sulfur compounds containing elemental sulfur and H₂S-sulfurized hydrocarbons (diisobutylene, terpene); sulfurized glycerides and fatty acid esters; overbased sulfonates; chlorine compounds or solids such as graphite or molybdenum disulfide.

A further preferred group of additives is that of friction modifiers. The friction modifiers used may include mechanically active compounds, for example molybdenum disulfide, graphite (including fluorinated graphite), poly(trifluoroethylene), polyamide, polyimide; compounds which form adsorption layers, for example long-chain carboxylic acids, fatty acid esters, ethers, alcohols, amines, amides, imides; compounds which form layers through tribochemical reactions, for example saturated fatty acids, phosphoric acid and thiophosphoric esters, xanthogenates, sulfurized fatty acids; compounds which form polymer-like layers, for example ethoxylated dicarboxylic acid partial esters, dialkyl phthalates, methacrylates, unsaturated fatty acids, sulfurized olefins or organometallic compounds, for example molybdenum compounds (molybdenum dithiophosphates and molybdenum dithiocarbamates MoDTC) and their combinations with ZnDTPs, copper-containing organic compounds.

Some of the compounds detailed above may fulfill multiple functions. ZnDTP, for example, is primarily an antiwear additive and extreme pressure additive, but also has the character of an antioxidant and corrosion inhibitor (here: metal passivator/deactivator).

The additives detailed above are described in more detail, inter alia, in T. Mang, W. Dresel (eds.): “Lubricants and Lubrication”, Wiley-VCH, Weinheim 2001; R. M. Mortier, S. T. Orszulik (eds.): “Chemistry and Technology of Lubricants”.

Preferred lubricant oil compositions have a viscosity, measured at 40° C. to ASTM D 445, in the range of 10 to 120 mm²/s, more preferably in the range of 22 to 100 mm²/s. The kinematic viscosity KV₁₀₀ measured at 100° C. is preferably at least 5.5 mm²/s, more preferably at least 5.6 mm²/s and most preferably at least 5.8 mm²/s.

In a particular aspect of the present invention, preferred lubricant oil compositions have a viscosity index determined to ASTM D 2270 in the range from 100 to 400, more preferably in the range from 150 to 350 and most preferably in the range from 175 to 275.

Lubricant oil compositions which are additionally of particular interest are those which have a high-temperature high-shear viscosity HTHS measured at 150° C. of at least 2.4 mPas, more preferably at least 2.6 mPas. The high-temperature high-shear viscosity HTHS measured at 100° C. is preferably at most 10 mPas, more preferably at most 7 mPas and most preferably at most 5 mPas. The difference between the high-temperature high-shear viscosities HTHS measured at 100° C. and 150° C., HTHS₁₀₀-HTHS₁₅₀, is preferably at most 4 mPas, more preferably at most 3.3 mPas and most preferably at most 2.5 mPas. The ratio of high-temperature high-shear viscosity at 100° C. HTHS₁₀₀ to high-temperature high-shear viscosity at 150° C. HTHS₁₀₀/HTHS₁₅₀, is preferably at most 2.0, more preferably at most 1.9. The high-temperature high-shear viscosity HTHS can be measured at the particular temperature to ASTM D4683.

In an appropriate modification, the permanent shear stability index (PSSI) to ASTM D2603 ref. B (ultrasound treatment for 12.5 minutes) may be less than or equal to 35, more preferably less than or equal to 20. Advantageously, it is also possible to obtain lubricant oil compositions which have a permanent shear stability index (PSSI) to DIN 51381 (30 cycles of a Bosch pump) of at most 5, preferably at most 2 and most preferably at most 1.

The present lubricants can be used especially as a transmission oil, motor oil or hydraulic oil. Surprising advantages can be achieved especially when the present lubricants are used in manual, automated manual, double clutch or direct-shift gearboxes (DSG), automatic and continuous variable transmissions (CVCs). In addition, the present lubricants can be used especially in transfer cases and axle or differential gearings.

The present comb polymers serve especially as antifatigue additives in lubricants. It has been found that, surprisingly, these additives counteract material fatigue, such that the lifetime of transmissions, engines or hydraulic systems can be increased. This finding can be established by various methods. The fatigue time (crater resistance) of the lubricant oil formulations can be determined either by methods for gearings or for roller bearings. The methods which follow cover a wide range of Hertzian pressures.

The fatigue time (number of rotations) can be determined, for example, on a four-ball apparatus (FBA) standardized to DIN 51350-1, in which a rotating ball under load is pressed onto three identical, likewise rotating balls. The test method employed is VW-PV-1444 of Volkswagen AG (“Grübchenfestigkeit von Bauteilen mit Wälzreibung—Pittingtest” [Crater resistance of components with rolling friction—pitting test], VW-PV-1444, Volkswagen AG).

The test temperature is 120° C. With a load of 4.8 kN and a rotational speed of 4000 rpm, the entrainment speed is 5.684 m/s at a maximum Hertzian pressure of 7.67 GPa. Fatigue sets in as soon as an acceleration sensor registers vibrations in the frequency band of the rollover frequencies of the test bodies greater than 0.25 g (acceleration due to gravity g=9.81 m/s²). This typically indicates craters on the rolling path of diameter 1-2 mm. This test is referred to hereinafter as the FBA test.

In addition, fatigue can be determined by means of an FAG FE8 test. To this end, the FE8 roller bearing lubricant test rig to DIN 51819-1 from FAG (Schaeffler KG, Schweinfurt) can be used. Here, the fatigue time (in hours) of two cylindrical roller thrust bearings mounted together in each case is examined according to test method VW-PV-1483 (“Prüfung der Grübchentragfähigkeit in Wälzlagern—Ermüdungstest” [Testing of crater resistance in roller bearings fatigue test], VW-PV-1483, Volkswagen AG, drafted September 2006; constituent of oil standards VW TL52512/2005 for manual transmissions and VW TL52182/2005 for double-clutch transmissions of Volkswagen AG). Bearing washers with an arithmetic roughness of 0.1-0.3 μm are used.

Testing is effected at 120° C. With a load of 60 kN and a rotational speed of 500 rpm, the entrainment speed is 1.885 m/s at a maximum Hertzian pressure of 1.445 GPa. Fatigue occurs as soon as the torque (i.e. the moment of friction) has an increase by more than 10%, i.e. even in the case of fatigue only to one cylindrical roller thrust bearing.

In principle, the FE8 roller bearing lubricant test rig can also be operated according to the more severe ZF-702-232/2003 method of ZF Friedrichshafen AG (cf. “ZF Bearing Pitting Test”, ZF-702-232, ZF Friedrichshafen AG, 2004).

The Unisteel Machine according to IP 305/79 based on a roller bearing with 11 balls (in modifications also only with 3 balls), which is widespread in industry, offers another method of determining the fatigue time of bearings.

In addition, it is possible to use a gear rig test machine from FZG (Institute for Machine Elements—Gear Research Center of the Technical University of Munich) to DIN 51354-1. On this test machine, the fatigue time (in hours) is determined using specified PT-C (pitting test type C) gears. The method is described in FVA Information Sheet 2/IV (cf. U. Schedl: “FVA-Forschungsvorhaben 2/IV: Pittingtest—Einfluss der Schmierstoffs auf die Grübchenlebensdauer einsatzgehärteter Zahnräder im Einstufen- and Lastkollektivversuch”, Forschungsvereinigung Antriebstechnik, Book 530, Frankfurt 1997; “Pittingtest—Einfluss der Schmierstoffs auf die Grübchenlebensdauer einsatzgehärteter Zahnräder im Einstufen- and Lastkollektivversuch”, FVA Information Sheet 2/IV, Forschungsvereinigung Antriebstechnik, Frankfurt 1997).

Testing is effected at 120° C. At load level 10 (i.e. a torque of 373 Nm) and a rotational speed of 1450 rpm, the entrainment speed is 5.678 m/s at a maximum Hertzian pressure of 1.834 GPa. Fatigue occurs when craters of total area >=5 mm² are observed. This method is referred to hereinafter as FZG PT-C 10/120 test.

The utilization of the further-developed PTX-C test gearing, which is close to reality, in the FZG gear rig test machine to DIN 51354-1 leads to improved repeatability and comparability of the fatigue time. The method is described in FVA Information Sheet 371 (cf. T. Radev: “FVA-Forschungsvorhaben 371: Entwicklung eines praxisnahen Pittingtests”, Forschungsvereinigung Antriebstechnik, Book 710, Frankfurt 2003; “Development of a Practice Relevant Pitting Test”, FVA Information Sheet 371, Forschungsvereinigung Antriebstechnik, Frankfurt 2006).

Testing is effected at 90° C. At load level 10 (i.e. a torque of 373 Nm) and a rotational speed of 1450 rpm, the entrainment speed is 5.678 m/s at a maximum Hertzian pressure of 2.240 GPa. Fatigue occurs when craters of total area >=5 mm² are observed. This method is referred to hereinafter as FZG PTX-C 10/90 test.

The present invention will be illustrated in detail hereinafter with reference to examples and comparative examples, without any intention that this should impose a restriction.

### Preparation of the Macromonomer

The macroalcohol used was a hydroxyethyl-terminated, hydrogenated polybutadiene with a mean molar mass Mn=4800 g/mol. The vinyl content of the macromonomer was 55%, the degree of hydrogenation >98.5% and the —OH functionality >90%; all these values were determined by H NMR (nuclear resonance spectroscopy).

In a 2 l stirred apparatus equipped with a saber stirrer, air inlet tube, thermocouple with regulator, heating mantle, column packed with 4 mm Raschig ring random packings, vapor divider, top thermometer, reflux condenser and substrate condenser, 1200 g of macroalcohol were dissolved in 400 g of MMA by stirring at 60° C. 32 mg of 2,2,6,6-tetramethylpiperidine-1-oxyl radical and 320 mg of hydroquinone monomethyl ether were added to the solution. After heating to MMA reflux (bottom temperature about 110° C.) while passing air through for stabilization, about 20 g of MMA were distilled off for azeotropic drying. After cooling to 95° C., 0.30 g of LiOH was added and the mixture was heated again to reflux. After a reaction time of approx. 1 hour, the top temperature had fallen to ˜64° C. due to methanol formation. The methanol/MMA azeotrope formed was constantly distilled off until a constant top temperature of about 100° C. was established again. At this temperature, the mixture was allowed to react for a further hour. For further workup, the bulk of MMA was drawn off under reduced pressure and then the viscous “crude macromonomer” was diluted by adding 514.3 g of KPE 100N oil. Insoluble catalyst residues were removed by pressure filtration (Seitz T1000 depth filter). This gave approx. 1650 g of macromonomer solution in oil. The content of KPE 100N oil in the comb polymer syntheses described below was taken into account correspondingly.

### Polarity Determination by Gradient HPLC

The polarity of the polymers was determined with reference to the elution characteristics thereof from defined HPLC column material. This involved dissolving a particular amount of polymer in i-octane (=nonpolar solvent) and applying it to a CN-functionalized silica column (Nucleosil CN-25). Later in the experiment, the eluent composition was altered continuously by adding tetrahydrofuran, THF, until the eluent was strong enough to desorb the polymer applied again. The polarity determined accordingly corresponds to the proportion by volume of THF needed for desorption in the eluent.

### Apparatus:

A liquid chromatograph from Agilent, series 1200, was used, consisting of: 2 binary HPLC pumps with mixers, solvent degassing unit, autosampler, column oven and diode array detector. For polymer detection, an evaporative light scattering detector from Alltech, 2000 type, was used. The column material used was a commercially available HPLC column of the Nucleosil-CN type, column dimensions 250×4 mm, porosity 10 μm. The two solvents, i-octane and THF, were purchased in HPLC quality from Merck and used without further purification.

### Method:

The polymers were dissolved in THF with a mass concentration of 5 g/l. Before each analysis, the column was rinsed with pure i-octane for at least 5 minutes. For the measurement, 10 μl were injected onto the column via the autosampler. The injection of the sample was followed by elution with pure i-octane at a flow rate of 1 ml/min for another 2 min, then 5% by volume of THF were supplied per minute. 22 minutes after the start, the eluent consisted only of THF. After isocratic elution with THF for 1 minute, the flow was switched back to pure i-octane within 0.1 min.

### Evaluation:

For evaluation, the elution time of the peak maximum was used, although the system volume (volume of the column and connecting lines) also has to be incorporated into the calculation of the THF content. The system volume in the test setup described was 2.50 ml, and with the flow rate of 1 ml/min used accordingly 2.50 min. The proportion of THF needed for elution is accordingly calculated as follows:

% THF=(tₑₗᵤₜᵢₒₙ−t_{system}−t_{isocratic})*THF-gradient/min, giving with an elution time of 7.32 min:

$$\% THF = ( 7.32 min - 2.50 min - 2.00 min ) * \frac{5.0 \%}{min} = 14.10 \% THF$$

Some inventive polymers did not elute with pure THF; their adsorptive forces were so strong that desorption even with pure THF was impossible. The polarity values thereof were therefore reported as >100%.

### Abbreviations

In the description which follows, the following abbreviations are used:

MM1: methacrylic ester of the above-described macroalcohol
AMA1: methacrylic ester of a synthetic iso-C13 alcohol, iso content >60%
AMA: methacrylic ester of a linear C12-C14 alcohol
BMA: n-butyl methacrylate
MMA: methyl methacrylate
Sty: styrene
DMAEMA: N,N-dimethylaminoethyl methacrylate

### DMAPMAm: N,N-dimethylaminomethacrylamide

### NVP: N-vinylpyrrolidone

BDtBPB: 2,2-bis(tert-butylperoxy)butane
DDM: dodecyl mercaptan
tBPO: tert-butyl peroctoate
tBPB: tert-butyl perbenzoate
CuCl: copper(I) chloride
PMDETA: N,N,N′,N″,N″-pentamethyldiethylenetriamine
EBiB: ethyl 2-bromo-2-methylpropionate
MOEMA: morpholinoethyl methcrylate

### COMPARATIVE EXAMPLE 1

A 4-neck round-bottom flask with thermometer, heating mantle, nitrogen blanketing, stirrer and reflux condenser was initially charged with 704.8 g of AMA1, 89.91 g of KPE 100N oil and 9.87 g of DDM. While stirring and under a nitrogen blanket, the mixture was heated to 110° C. On attainment of internal temperature 110° C., a solution of 1.76 g of tBPO and 5.29 g of KPE 100N oil was metered in within 3 hours as follows: 5% of the initiator solution within the 1^{st} hour, 25% within the 2^{nd} hour and 70% of the solution within the 3^{rd} hour. The internal temperature was kept constant at 110° C. 45 minutes after the end of the feed, another 1.41 g of tBPO were added and the mixture was stirred at 110° C. for a further 60 minutes. 800 g of a viscous solution were obtained. The limiting viscosity and the polarity of the polymer were determined, and the results obtained by the methods detailed above are reported in table 1.

### COMPARATIVE EXAMPLE 2

First, the base polymer was prepared. 29.4 g of monomer mixture (75% AMA and 25% MMA) and 0.0883 g of DDM were charged together with 265 g of 100N oil into a 2 l 4-neck round-bottom flask with saber stirrer, condenser, thermometer, feed pump and N2 blanketing. The apparatus was inertized and heated to 100° C. by means of an oil bath. Once the mixture in the reaction flask attained a temperature of 100° C., 2.26 g of tBPO were added. At the same time, a mixture of 706 g of the abovementioned monomer mixture, 2.12 g of DDM and 19.8 g of tBPO was metered in homogeneously at 105° C. within 3.5 hours. 2 h after the end of the feed, another 1.47 g of tBPO were added at 105° C. This gave 1000 g of a clear viscous solution. The resulting 1000 g of base polymer solution were mixed with 22.7 g of NVP, and 1.89 g of tBPB were added at 130° C. This was replenished 1 h, 2 h and 3 h after the first addition with 0.947 g each time of tBPO at 130° C. After stirring for a further hour, the mixture was diluted again with 100N oil to a solids content of 73.5%. A clear, pale reddish, viscous solution was obtained. The limiting viscosity and the polarity of the polymer were determined, and the results obtained by the methods detailed above are reported in table 1.

### COMPARATIVE EXAMPLE 3

An apparatus consisting of a 2 l 4-neck round-bottom flask with dropping funnel, saber stirrer, condenser, thermometer and N2 feedline was used. The reaction flask was first initially charged with 463 g of AMA, 56 g of 100N oil, 1.5 g of CuCl and 2.7 g of PMDETA, and inertized with stirring. The mixture was a heterogeneous mixture since the complex catalyst had only dissolved incompletely. During the heating operation, the reaction was initiated with 6.1 g of EBiB at about 65° C. After noticeable exothermic reaction, the mixture was allowed to react at 95° C. for 2 h. At a conversion of ˜90% of the initially used AMA, 37.5 g of MOEMA were added dropwise within 5 min and allowed to react at 95° C. for a further 4 h. Subsequently, the mixture was diluted to 50% with 100N oil and pressure-filtered while warm to remove the CuCl (Seitz T1000 10 μm depth filter). This gave a 50% reddish solution. The limiting viscosity and the polarity of the polymer were determined, and the results obtained by the methods detailed above are reported in table 1.

### EXAMPLE 1

In a beaker, the following reaction mixture was made up: 90.0 g of 70% macromonomer solution in oil, 0.3 g of AMA, 12.6 g of BMA, 68.7 g of Sty, 0.3 g of MMA, 5.1 g of DMAEMA, 65.0 g of Shell Risella 907 (light naphthenic/paraffinic base oil) and 8.0 g of KPE 100N oil. A 500 ml 4-neck round-bottom flask with saber stirrer, nitrogen blanketing, thermometer, oil bath with closed-loop regulation and reflux condenser was initially charged with 50 g of the reaction mixture and heated to 120° C. while stirring. During the heating phase, nitrogen was passed through the reaction flask for inertization. On attainment of 120° C., 0.06 g of BDtBPB was introduced into the reaction flask; at the same time, the feed consisting of the rest of the reaction mixture and 0.24 g of BDtBPB was started. The feed time was 3 hours; the reaction temperature was kept constant at 120° C. 2 and 5 hours after the feed had ended, another 0.30 g each time of BDtBPB was added and, the next day, the contents of the flask were diluted to a solids content of 40% by adding oil. 375 g of a high-viscosity, clear solution were obtained. The limiting viscosity and the polarity of the polymer were determined, and the results obtained by the methods detailed above are reported in table 1.

### EXAMPLE 2

In a beaker, the following reaction mixture was made up: 94.3 g of 70% macromonomer solution in oil, 0.3 g of AMA, 12.6 g of BMA, 65.7 g of Sty, 0.3 g of MMA, 5.1 g of DMAPMAm, 65.0 g of Shell Risella 907 (light naphthenic/paraffinic base oil) and 6.7 g of KPE 100N oil. A 500 ml 4-neck round-bottom flask with saber stirrer, nitrogen blanketing, thermometer, oil bath with closed-loop regulation and reflux condenser was initially charged with 50 g of the reaction mixture and heated to 120° C. while stirring. During the heating phase, nitrogen was passed through the reaction flask for inertization. On attainment of 120° C., 0.06 g of BDtBPB was introduced into the reaction flask; at the same time, the feed consisting of the rest of the reaction mixture and 0.24 g of BDtBPB was started. The feed time was 3 hours; the reaction temperature was kept constant at 120° C. 2 and 5 hours after the feed had ended, another 0.30 g each time of BDtBPB was added and, the next day, the contents of the flask were diluted to a solids content of 40% by adding oil. 375 g of a high-viscosity, clear solution were obtained. The limiting viscosity and the polarity of the polymer were determined, and the results obtained by the methods detailed above are reported in table 1.

### EXAMPLE 3

In a beaker, the following reaction mixture was made up: 90.0 g of 70% macromonomer solution in oil, 27.0 g of BMA, 60.0 g of Sty, 65.0 g of Shell Risella 907 (light naphthenic/paraffinic base oil) and 8.0 g of KPE 100N oil. A 500 ml 4-neck round-bottom flask with saber stirrer, nitrogen blanketing, thermometer, oil bath with closed-loop regulation and reflux condenser was initially charged with 50 g of the reaction mixture and heated to 120° C. while stirring. During the heating phase, nitrogen was passed through the reaction flask for inertization. On attainment of 120° C., 0.09 g of BDtBPB was introduced into the reaction flask; at the same time, the feed consisting of the rest of the reaction mixture and 0.36 g of BDtBPB was started. The feed time was 3 hours; the reaction temperature was kept constant at 120° C. 2 hours after the feed had ended, another 0.30 g of BDtBPB was added. 5 hours after the feed had ended, the mixture was heated to 130° C., 5.3 g of NVP were stirred in and, after 5 minutes, 0.39 g of tBPB was added. This was replenished in each case after 1, 2 and 3 hours after the first tBPB addition with another 0.19 g of tBPB. After the reaction had ended, the mixture was diluted to a solids content of 40% with oil. 380 g of a high-viscosity, slightly cloudy solution were obtained. The limiting viscosity and the polarity of the polymer were determined, and the results obtained by the methods detailed above are reported in table 1.

### EXAMPLE 4

A 500 ml 4-neck round-bottom flask with saber stirrer, nitrogen blanketing, thermometer, oil bath under closed-loop control and reflux condenser was initially charged with 107.1 g of 70% macromonomer solution in oil, 44.1 g of AMA, 0.3 g of BMA, 0.3 g of Sty, 0.3 g of MMA, 30.0 g of DMAPMAm, 26.5 g of 100N oil and 1.50 g of DDM, and heated to 110° C. while stirring. During the heating phase, nitrogen was passed through the reaction flask for inertization. On attainment of internal temperature 110° C., a solution of 0.30 g of tBPO and 5.70 g of KPE 100N oil was metered in within 3 hours. This was replenished 1 and 2 hours after the feed had ended with in each case 0.30 g of tBPO at 100° C. ˜210 g of a viscous solution were obtained. The limiting viscosity and the polarity of the polymer were determined, and the results obtained by the methods detailed above are reported in table 1.

### EXAMPLE 5

A 500 ml 4-neck round-bottom flask with saber stirrer, nitrogen blanketing, thermometer, oil bath under closed-loop control and reflux condenser was initially charged with 171.4 g of 70% macromonomer solution in oil, 14.1 g of AMA, 0.3 g of BMA, 0.3 g of Sty, 0.3 g of MMA, 15.0 g of DMAPMAm, 7.2 g of 100N oil and 1.20 g of DDM, and heated to 110° C. while stirring. During the heating phase, nitrogen was passed through the reaction flask for inertization. On attainment of internal temperature 110° C., a solution of 0.30 g of tBPO and 5.70 g of KPE 100N oil was metered in within 3 hours. This was replenished 1 and 2 hours after the feed had ended with in each case 0.30 g of tBPO at 100° C.-210 g of a viscous solution were obtained. The limiting viscosity and the polarity of the polymer were determined, and the results obtained by the methods detailed above are reported in table 1.

TABLE 1
Properties of the polymers prepared

| | Retention | | Limiting |
|---|---|---|---|
| | time | Polarity | viscosity |
| | [minutes] | [% THF] | [ml/g] |
| Comparative example 1 | 7.50 | 15.0 | 8.1 |
| Comparative example 2 | 9.36 | 24.3 | 16.0 |
| Comparative example 3 | — | — | 8.7 |
| Example 1 | >24.5 | >100 | 58.4 |
| Example 2 | >24.5 | >100 | 63.8 |
| Example 3 | 11.05 | 32.8 | 58.0 |
| Example 4 | >24.5 | >100 | 23.8 |
| Example 5 | >24.5 | >100 | — |

### Evaluation of the Comb Polymers

A fully formulated but VI improver-free base fluid comprising API (American Petroleum Institute) group III base oil plus DI package (dispersant inhibitor package) comprising dispersant, detergent, defoamer, corrosion inhibitor, antioxidant, antiwear and extreme pressure additives, friction modifier) of KV40=22.32 cSt, KV100=4.654 cSt and VI=128 was used.

The polymers obtained were adjusted to KV100=6.5 cSt (ASTM D445) in the base fluid detailed above. The typical formulation parameters KV40 and viscosity index VI (ASTM 2270) were determined; the values obtained can be found in table 2.

TABLE 2
Viscometry data of the synthesized polymers
in a lubricant oil formulation

| | Amount of | | | |
|---|---|---|---|---|
| | polymer | KV40 | KV100 | |
| Polymer according to | added in % | [mm²/s] | [mm²/s] | VI |
| Comparative example 1 | 7.2 | 32.24 | 6.52 | 161 |
| Comparative example 2 | 5.8 | 31.52 | 6.51 | 167 |
| Comparative example 3 | 6.75 | 31.55 | 6.54 | 169 |
| Example 1 | 3.16 | 29.27 | 6.54 | 189 |
| Example 2 | 2.88 | 29.12 | 6.43 | 183 |
| Example 3 | 2.6 | 28.41 | 6.42 | 189 |
| Example 4 | 3.29 | 33.42 | 6.54 | 154 |
| Example 5 | 2.73 | 33.54 | 6.54 | 154 |

The fatigue time (number of rotations) is determined on a four-ball apparatus (FBA) standardized to DIN 51350 1, in which a rotating ball is pressed under load onto three identical, likewise rotating balls. The test method employed is VW PV 1444 of Volkswagen AG.

The test temperature was 120° C. With a load of 4.8 kN and a rotational speed of 4000 rpm, the entrainment speed was 5.684 m/s at a maximum Hertzian pressure of 7.67 GPa. Fatigue set in as soon as an acceleration sensor registered vibrations in the frequency band of the rollover frequencies of the test bodies greater than 0.25 g (acceleration due to gravity g=9.81 m/s²). This typically indicated craters on the rolling path of diameter 1-2 mm.

The determination of a fatigue time required several (preferably 5-10) tests under the same operating conditions. A fatigue time can be represented either as an arithmetic mean or, with the aid of Weibull statistics, as a mean fatigue time of unreliability U. U is typically 50% (or 10%), which means that 50% of all samples have shown fatigue up to the time reported. Unreliability should not be confused with the statistical confidence level, which is typically 90% (or 95%).

The greater the duration, i.e. the number of rotations until material fatigue damage sets in, the better the effect of the polymer disclosed in the test oil. The data obtained are shown in table 3.

TABLE 3
Results of studies on fatigue performance

| | Evaluation | |
|---|---|---|
| | according to | Evaluation by |
| | Weibull statistics | arithmetic |
| | 50% [number | mean [number |
| Polymer according to | of rotations] | of rotations] |
| Comparative example 1 | 108 040 | 107 123 |
| Comparative example 2 | 148 775 | 147 903 |
| Comparative example 3 | 150 550 | 149 133 |
| Example 1 | 168 300 | 166 701 |
| Example 2 | 213 420 | 211 489 |
| Example 3 | 163 920 | 162 800 |
| Example 4 | 175 430 | 173 713 |
| Example 5 | 155 465 | 153 190 |

The results shown in table 3 demonstrate clearly that the inventive dispersing comb polymers have a very positive effect on the lifetime, for example, of a roller bearing. The use of the inventive comb polymers enables extensions of the lifetime of up to 41%.

1. A lubricant comprising a comb polymer comprising, in the main chain, repeat units derived from a polyolefin-based macromonomer with a molecular weight of at least 500 g/mol, and repeat units derived from a low molecular weight monomer with a molecular weight less than 500 g/mol.

2. The lubricant as claimed in claim 1, wherein the comb polymers have repeat units derived from a dispersing monomer.

3. The lubricant as claimed in claim 2, wherein the dispersing monomer is a heterocyclic vinyl compound and/or an aminoalkyl (meth)acrylate, an aminoalkyl(meth)acrylamide, a hydroxyalkyl (meth)acrylate, a heterocyclic (meth)acrylate and/or a carbonyl-containing (meth)acrylate.

4. The lubricant as claimed in claim 1, wherein the comb polymer has a weight-average molecular weight M_{w} in the range from 20 000 to 1 000 000 g/mol.

5. The lubricant as claimed in claim 1, wherein the comb polymer has an number-average molecular weight Mₙ in the range from 10 000 to 800 000 g/mol.

6. The lubricant as claimed in claim 1, wherein the lubricant is a transmission oil, motor oil or hydraulic oil.

7. A comb polymer comprising, in the main chain, repeat units derived from a polyolefin-based macromonomer with a molecular weight of at least 500 g/mol, and repeat units derived from low molecular weight monomers with a molecular weight less than 500 g/mol, wherein the comb polymer has repeat units derived from an alkyl (meth)acrylate having 8 to 30 carbon atoms in the alcohol group, a polarity of at least 50% THF and a limiting viscosity in the range from 15 to 50 ml/g.

8. The comb polymer as claimed in claim 7, wherein the comb polymer has at least 10% by weight of repeat units derived from a dispersing monomer.

9. The comb polymer as claimed in claim 7, wherein the ratio of the number-average molecular weight Mₙ of the polyolefin-based macromonomer to the number-average molecular weight Mₙ of the comb polymer is in the range from 1:3 to 1:5.

10. The comb polymer as claimed in claim 7, wherein the comb polymer has at least 5% by weight of repeat units derived from the alkyl (meth)acrylate having 8 to 30 carbon atoms in the alcohol group.

11. The comb polymer as claimed in claim 8, wherein the comb polymer has 30 to 80% by weight of repeat units derived from the polyolefin-based macromonomer.

12. The comb polymer as claimed in claim 11, wherein the weight ratio of repeat units derived from the polyolefin-based macromonomer to the repeat units derived from the dispersing monomer is in the range from 6:1 to 2:1.

13. The comb polymer as claimed in claim 8, wherein the weight ratio of repeat units derived from the alkyl (meth)acrylate having 8 to 30 carbon atoms in the alcohol group to the repeat units derived from the dispersing monomer is in the range from 2:1 to 1:1.5.

14. The comb polymer as claimed in claim 7, wherein the comb polymer has repeat units derived from methyl methacrylate and repeat units derived from n-butyl methacrylate.

15. The comb polymer as claimed in claim 8, wherein the comb polymer has units derived from an aminoalkyl(meth)acrylamide as a dispersing monomer.

16. A comb polymer comprising, in the main chain, repeat units derived from a polyolefin-based macromonomer with a molecular weight of at least 500 g/mol, and repeat units derived from a low molecular weight monomer with a molecular weight less than 500 g/mol, wherein the comb polymer has at least 10% by weight of repeat units derived from a styrene monomer having 8 to 17 carbon atoms, at least 5% by weight of repeat units derived from an alkyl (meth)acrylate having 1 to 6 carbon atoms, and a polarity of at least 30% THF.

17. The comb polymer as claimed in claim 16, wherein the comb polymer has a polarity of at least 80% THF.

18. The comb polymer as claimed in claim 16, wherein the comb polymer has a limiting viscosity number in the range from 40 to 100 ml/g.

19. The comb polymer as claimed in claim 16, wherein the ratio of the number-average molecular weight Mₙ of the polyolefin-based macromonomer to the number-average molecular weight Mₙ of the comb polymer is in the range from 1:10 to 1:50.

20. The comb polymer as claimed in claim 18, wherein the comb polymer has 1 to 8% by weight of repeat units derived from a dispersing monomer.

21. The comb polymer as claimed in claim 16, wherein the ratio of the number-average molecular weight Mₙ of the polyolefin-based macromonomer to the number-average molecular weight Mₙ of the comb polymer is in the range from 1:10 to 1:50.

22. The comb polymer as claimed in claim 16, wherein the comb polymer has 30 to 60% by weight of repeat units derived from the polyolefin-based macromonomer with a molecular weight of at least 500 g/mol.

23. The comb polymer as claimed in claim 20, wherein the weight ratio of repeat units derived from the polyolefin-based to the repeat units derived from the dispersing monomer is in the range from 30:1 to 8:1.

24. The comb polymer as claimed in claim 20, wherein the comb polymer has units derived from an aminoalkyl(meth)acrylamide as a dispersing monomer.

25. The comb polymer as claimed in claim 16, wherein the comb polymer has repeat units derived from the methyl methacrylate and repeat units derived from the alkyl (meth)acrylate having 8 to 30 carbon atoms in the alcohol group.

26. A process for preparing comb polymers as claimed in claim 7, comprising copolymerizing the macromonomer and the low molecular weight monomer.

27. The process as claimed in claim 26, wherein the copolymerization is effected by means of free-radical polymerization.

28. A lubricant oil formulation comprising comb polymers as claimed in claim 7.

29. The lubricant oil formulation as claimed in claim 28, having a PSSI to ASTM D2603 ref. B is less than or equal to 35.
